(19) United States
(12) Patent Application Publication
(10) Pub. No.: US 2015/0201570 A1
(43) Pub. Date: Jul. 23, 2015

(54) WATERING CONTROL METHOD BY MONITORING SOIL MOISTURE

(71) Applicants: MOU-LI LIN, TAINAN CITY (TW); TA-CHI LIU, TAINAN CITY (TW); WEI-CHENG CHEN, TAICHUNG CITY (TW)

(72) Inventors: MOU-LI LIN, TAINAN CITY (TW); TA-CHI LIU, TAINAN CITY (TW); WEI-CHENG CHEN, TAICHUNG CITY (TW)

(21) Appl. No.: 14/336,032

(22) Filed: Jul. 21, 2014

(30) Foreign Application Priority Data
Jan. 23, 2014 (CN) 201420043332.3

(51) Int. Cl. A01G 25/16

(52) U.S. Cl. CPC A01G 25/167

(57) ABSTRACT

The invention provides a method of controlling watering by monitoring soil moisture, including the steps of: determining a control moisture and a measuring frequency; measuring a soil moisture according to the measuring frequency by a moisture sensor; implementing a watering process when the ratio of the soil moisture to the control moisture is lower than a first control value; implementing a waiting process after the watering process; measuring the soil moisture using the moisture sensor after finishing the waiting process; and implementing the step of measuring the soil moisture according to the measuring frequency by the moisture sensor when the ratio of the soil moisture to the control moisture is higher than a second control value, and implementing the watering process and the step of the waiting process when the ratio of the soil moisture to the control moisture is lower than the second control value.

### BACKGROUND OF THE INVENTION

1. Technical Field

The invention relates to a method of controlling watering by monitoring soil moisture, and more particularly, to a method of controlling watering by monitoring soil moisture using a moisture sensor and controlling the watering processes to work with an automatic watering device to water potted plants automatically and properly.

2. Description of the Related Art

U.S. Patent Application Publication No. 20070089365A1 “Plant watering system” has disclosed a plant watering system particularly suited for use in watering indoor, potted plants, includes a plurality of plant watering devices and a main controller. Each plant watering device includes a fluid reservoir, a fluid outlet from which fluid may be dispensed to an adjacent plant, and an electronically controlled flow controller for controlling the flow of fluid from the reservoir to the outlet. The main controller includes a user input and a control unit configured to generate watering device control signals. Control signals are transmitted from the main controller to each watering device wirelessly. A method of watering plants was also disclosed, and although it has been disclosed to water by specific amounts according to different plant types and environment, it has not been disclosed to evaluate the watering results of under- or over-watering which may cause the plants to wither or rot after finishing watering, and thus the plant watering system of the prior art is less than convenient for use.

### BRIEF SUMMARY OF THE INVENTION

A method of controlling watering by monitoring soil moisture is disclosed to overcome the shortcomings of the prior art.

The invention provides a method of controlling watering by monitoring soil moisture, comprising the steps of: setting a control moisture and a measuring frequency; measuring a soil moisture according to the measuring frequency using a moisture sensor; implementing a watering process when the ratio of the soil moisture to the control moisture is lower than a first control value; implementing a waiting process after finishing the watering process to let water sufficiently permeate in soil; measuring the soil moisture using the moisture sensor after finishing the waiting process; and implementing the step of using the soil moisture according to the measuring frequency using the moisture sensor when the ratio of the soil moisture to the control moisture is higher than a second control value, and implementing the watering process and the step of implementing the waiting process when the ratio of the soil moisture to the control moisture is lower than the second control value.

Preferably, the measuring frequency is once every 15 to 45 minutes.

Preferably, the first control value is between 0.5 and 0.7.

Preferably, the waiting process takes time of 25 to 35 minutes.

Preferably, the second control value is between 0.9 and 1.1.

The effects of the invention are:

1. By the method of controlling watering by monitoring soil moisture of the present invention, the soil moisture is measured at suitable time intervals according to the measuring frequency to prevent the soil from being dry for too long due to negligence; the control moisture is set to adapt the moisture range suitable for the plants to grow; by measuring the soil moisture according to the measuring frequency using the moisture sensor, the watering process is implemented when the ratio of the soil moisture to the control moisture is lower than the first control value to prevent the plants from withering due to lack of water. The waiting process is implemented after finishing the watering process to let the water sufficiently permeate in soil according to different soil permeability properties to prevent acquiring unrepresentative moisture data when the soil moisture is measured again due to the insufficient water permeation; the step of measuring the soil moisture according to the measuring frequency is implemented to ensure that the soil moisture is sufficient when the ratio of the soil moisture to the control moisture is higher than the second control value, and the watering process and the waiting process are returned to when the ratio of the soil moisture to the control moisture is lower than the second control value since the soil moisture is insufficient. By the repeated soil moisture detection and repeated implementation of the watering process, the plants may not wither due to under-watering nor rot due to over-watering.

2. The setting of the measuring frequency to be once every 15 to 45 minutes is more suitable to prevent the soil from being too dry and causing the plants to wither under a time interval that is too long.

3. The setting of the waiting process to take time of 25 to 35 minutes lets the water sufficiently permeate in soil after watering to prevent acquiring unrepresentative moisture data and ceasing the watering process before the moisture is sufficient.

4. The setting of the first control value to be between 0.5 and 0.7 starts the watering process when the soil moisture to be between 50% and 70% of the control moisture to prevent the soil from being too dry and causing the plants to wither; the setting of the second control value to be between 0.9 and 1.1 ceases watering when the soil moisture recovers to within ±10% of the control value to prevent the soil from being over-watered and cause the plants to rot.

### BRIEF DESCRIPTION OF THE SEVERAL VIEWS OF THE DRAWINGS

FIG. 1 is a flow chart of a method of controlling watering by monitoring soil moisture of the present invention;

FIG. 2 is a perspective exploded diagram of an automatic plant-watering device in an embodiment of the present invention using the method of controlling watering;

FIG. 3 is a detailed perspective exploded diagram of the automatic plant-watering device in the embodiment of the present invention using the method of controlling watering;

FIG. 4 is another angle view of the perspective exploded diagram of the automatic plant-watering device in the embodiment of the present invention using the method of controlling watering;

FIG. 5 is a partial perspective exploded diagram of the automatic plant-watering device in the embodiment of the present invention using the method of controlling watering;

FIG. 6 is another angle view of the partial perspective exploded diagram of the automatic plant-watering device in the embodiment of the present invention using the method of controlling watering;

FIG. 7 is a front-view diagram of the automatic plant-watering device in the embodiment of the present invention using the method of controlling watering;

FIG. 8 is a cross-section assembly diagram taken from the line 8-8 of FIG. 7 showing the automatic plant-watering device in the embodiment of the present invention when in use;

FIG. 9 is a schematic view showing how the automatic plant-watering device in the embodiment of the present invention using the method of controlling watering is configured in a pot for use;

FIG. 10 is a perspective diagram of an automatic plant-watering device in another embodiment of the present invention using the method of controlling watering;

FIGS. 11A and 11B are another angle views of the perspective diagram of the automatic plant-watering device in another embodiment of the present invention using the method of controlling watering, in which some components is omitted; and

FIG. 12 is a schematic view showing how the automatic plant-watering device in another embodiment of the present invention using the method of controlling watering is configured in a pot for use.

### DETAILED DESCRIPTION OF THE INVENTION

The following embodiments shall demonstrate the main aspects of the invented method of controlling watering by monitoring soil moisture with the above technical features.

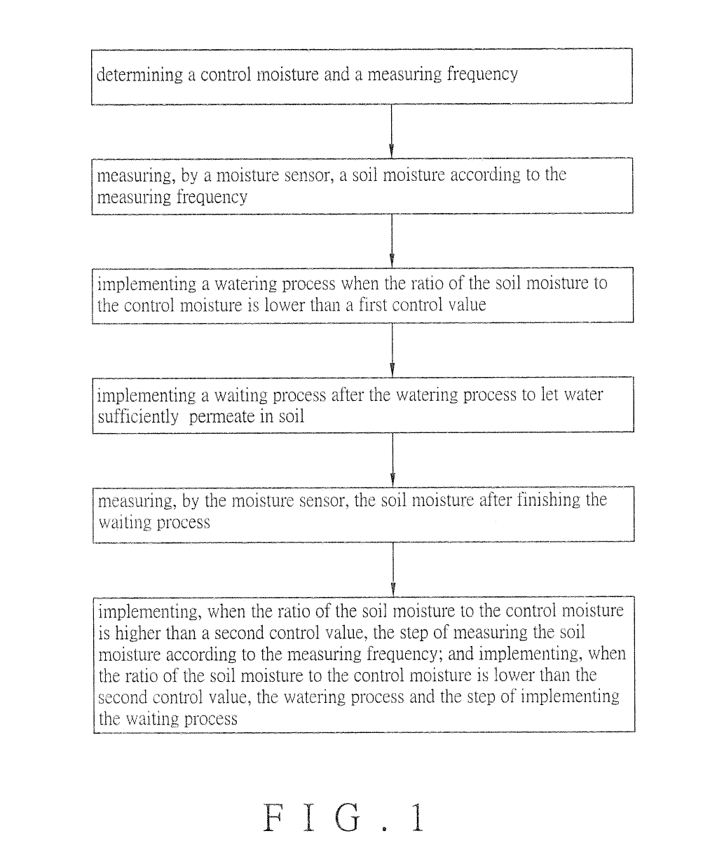

Referring to FIG. 1, the method of controlling watering by monitoring soil moisture of the invention comprises the steps of: (A) determining a control moisture and a measuring frequency, wherein the measuring frequency is once every 15 to 45 minutes and preferably once every 30 minutes; (B) measuring a soil moisture according to the measuring frequency using a moisture sensor; (C) implementing a watering process when the ratio of the soil moisture to the control moisture is lower than a first control value, wherein the first control value is between 0.5 and 0.7 and preferably 0.6, i.e., the soil moisture is 60% of the control moisture; (D) implementing a waiting process after finishing the watering process to let water sufficiently permeate in soil, wherein the waiting process takes time of 2.5 to 35 minutes and is mainly determined by the permeability of different soils, where soils with superior permeability require less time for the water to sufficiently permeate and soils with inferior permeability require more time for the water to sufficiently permeate, and the waiting process is preferably 30 minutes; (E) measuring the soil moisture using the moisture sensor after finishing the waiting process; and (F) implementing the step of measuring the soil moisture according to the measuring frequency using the moisture sensor when the ratio of the soil moisture to the control moisture is higher than a second control value, wherein the second control value is between 0.9 and 1.1 and preferably 1, i.e., the soil moisture is equal to the control moisture, and implementing the watering process and the step of implementing the waiting process when the ratio of the soil moisture to the control moisture is lower than the second control value.

The control moisture is set to adapt the moisture range suitable for the plants to grow. The soil moisture is measured by the moisture sensor at suitable time intervals, i.e., according to the measuring frequency, to prevent the soil from being dry for too long due to negligence, The watering process is implemented when the ratio of the soil moisture to the control moisture is lower than the first control value so that the plants are prevented from withering due to lack of water. The waiting process is implemented after the watering process in order for the water to sufficiently permeate in soil, thus avoiding acquiring unrepresentative moisture data due to the insufficient water permeation when the soil moisture is measured again, wherein the duration of the waiting process is determined by the soil permeability properties. After that, the soil moisture is measured again to make sure whether the soil moisture is sufficient or not. When the ratio of the soil moisture to the control moisture is higher than the second control value, the soil moisture is sufficient and the step of measuring the soil moisture according to the measuring frequency is then implemented to continuously monitor the soil moisture. When the ratio of the soil moisture to the control moisture is lower than the second control value, the watering process and the waiting process are returned to since the soil moisture is insufficient. In this manner, the soil moisture measurement and the watering process are repeated so that the plants may not wither due to under-watering nor rot due to over-watering.

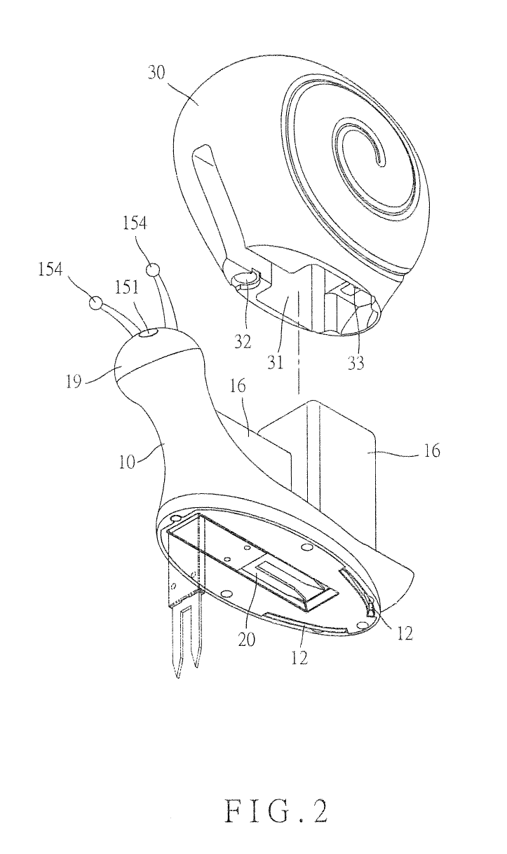

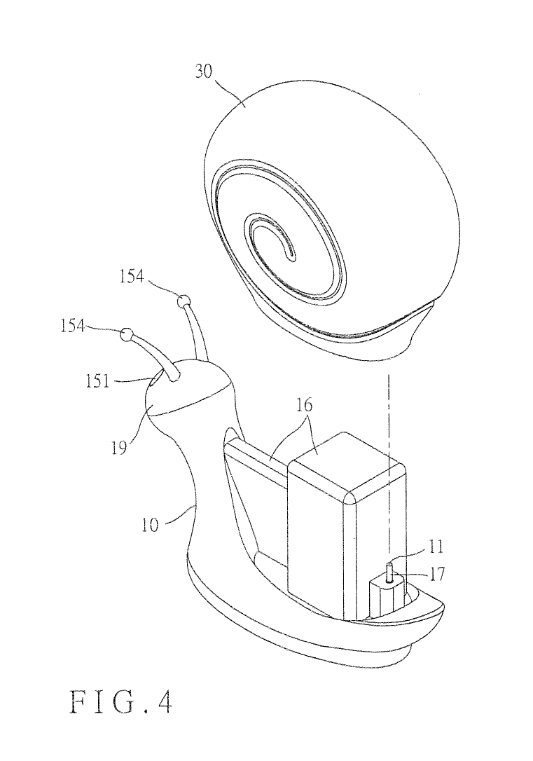

An automatic plant-watering device using the method of controlling watering is disclosed in the following. Referring to FIG. 2 to FIG. 4, the automatic plant-watering device comprises a carrier 10, a moisture sensor 20 configured below the carrier 10, and a reservoir 30 assembled on the above of the carrier 10.

The carrier 10 comprises an inlet 11 and an outlet 12. Furthermore, a main board 13, at least one battery 40 to provide power, and a motor pump 50 electrically connected to the main board 13 are configured inside the carrier 10, wherein the motor pump 50 comprises a first conduit device 51 connected to the inlet 11 and a second conduit device 52 connected to the outlet 12, and wherein the carrier 10 comprises a bottom lid 14 on which a battery box 141 able to contain four batteries 40 and combining with a detachable battery box cover 142 is configured.

The moisture sensor 20 is movably connected below the carrier 10 and is electrically connected to the main board 13. As shown in FIG. 2, the moisture sensor 20 is combined on the carrier 10 by pin connection and may move with respect to the carrier 10 to a packed position (the position shown in solid lines in FIG. 2) and to an operating position outside the carrier 10 (the position shown in dashed lines in FIG. 2). in other words, the moisture sensor 20 has the function of being packed in below of the carrier 10 to prevent being damaged by impact when in delivery or not being used. In addition to pin connection, in another embodiment, the moisture sensor 20 may also be movably connected to the carrier 10 by a push-type connection, and may be pushed or pulled to move into the packed position or the operation position.

The reservoir 30 is a hollow container capable of containing water, and the reservoir 30 has an exterior matching with that of the carrier 10 to be combined with each other by insertion as shown in the figures. The reservoir 30 is configured with a groove 31 corresponding in shape to the protrusion 16 on the rear of the carrier 10 so that the reservoir 30 may be inserted and combined above the carrier 10 in one.

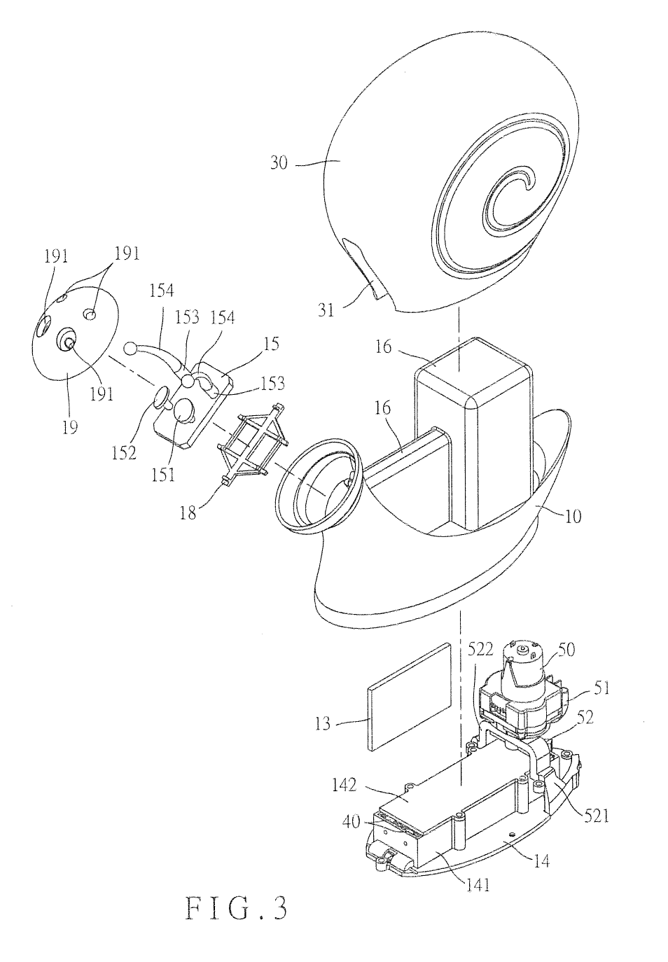

As shown in FIG. 2 and FIG. 3, an inlet 32 and an outlet 33 are configured at the bottom of the reservoir 30. When the reservoir 30 has no or insufficient water, it may be removed from the carrier 10 and refilled through the inlet 32.

The carrier 10 has a protruding inlet connector 17 that may insert into the outlet 33 correspondingly, and thus when the reservoir 30 is assembled above the carrier 10, the outlet 33 is aligned with the inlet 11 so that the water stored inside the reservoir 30 may flow into the inlet 11 of the carrier 10.

To determine whether water in the reservoir 30 is sufficient, the reservoir 30 is preferably to be transparent or semitransparent so that the user may tell by vision the amount of water inside the reservoir 30 from the outside. In another embodiment, the reservoir 30 may also be opaque and configured with a transparent or semitransparent mask at a proper position to observe the water amount.

It may be seen from the figures that a control board 15 is also configured inside the carrier 10. The control board 15 is electrically connected with the main board 13 and is configured with a moisture memory function key 151 and a forced watering function key 152 that are exposed on the carrier 10, wherein the forced watering function key 152 serves to drive the motor pump 50 to pump water. In addition, the control board 15 is also provided with two light-emitting devices 153 and two light guides 154. The light guides 154 are respectively connected to the light-emitting devices 153 and extend outside the carrier 10.

As illustrated in the figures, the automatic plant-watering device adapts an exterior design resembling a snail, and the control board 15 is configured on the head of the snail-shaped carrier 10 and is supported and aligned by an alignment plate 18; the two function keys 151 and 152 and the two light guides 154 exposed on the head of the carrier 10 resemble the eyes and tentacles of the snail, respectively. In order to install or replace components, a detachable casing lid 19 is configured on the head of the carrier 10, wherein the detachable casing lid 19 has a plurality of holes 191 to allow the two function keys 151 and 152 and the two light guides 154 to extend outside from the inside of the carrier 10.

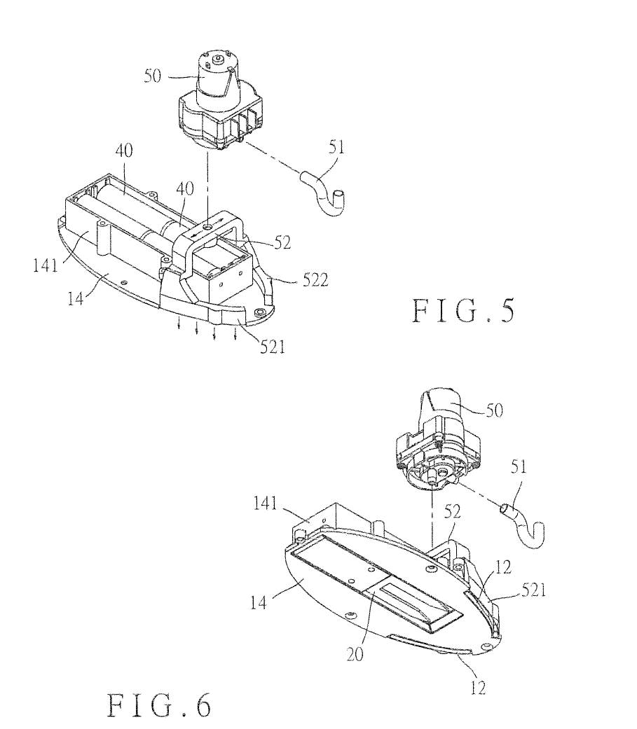

Referring to FIG. 5 and FIG. 6, the motor pump 50 comprises a first conduit device 51 connected to the inlet 11 of the carrier 10 and a second conduit device 52 connected to the outlet 12 of the carrier 10, wherein the first conduit device 51 may be a pipe and the water flowing into the inlet 11 of the carrier 10 from the reservoir 30 is passed to the second conduit device 52 via the motor pump 50 and discharged from the outlet 12 of the carrier 10 when the motor pump 50 is turned on.

As shown in the figures, the second conduit device 52 comprises two distributary conduits 521 and 522 extending to the left and the right, respectively (arrow directions in FIG. 5), to equally distribute the water pumped into the second conduit device 52 by the motor pump 50 to the two sides.

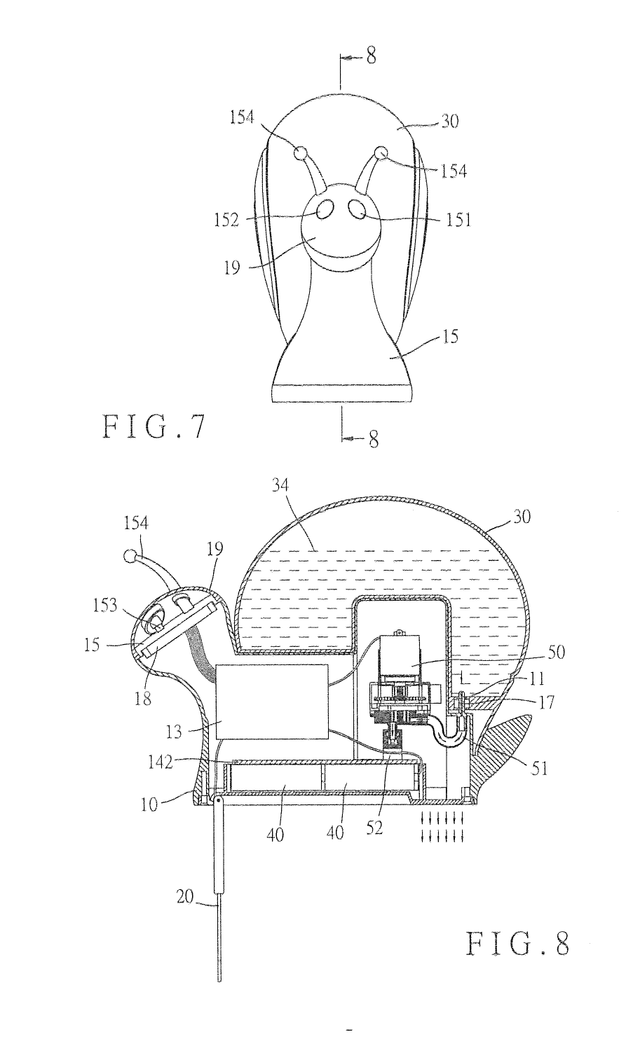

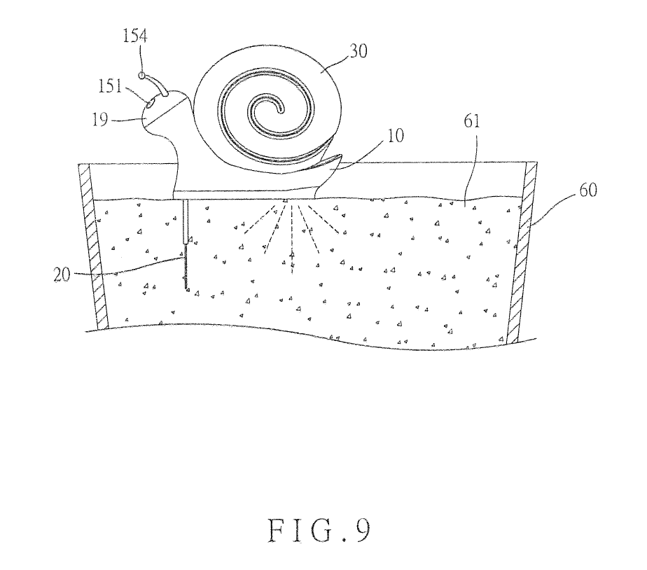

Referring to FIG. 7 to FIG. 9, after moving the moisture sensor 20 to the operating position downward vertically, the carrier 10 carrying the reservoir 30 may be inserted into soil 61 of a pot 60 by the moisture sensor 20; when the moisture memory function key 151 is pressed under suitable soil moisture conditions, the main board 13 saves this setting value, and the actual soil moisture subsequently measured by the moisture sensor 20 may be compared with the sett value to determine whether the soil 61 requires watering. When watering, the 34 stored in the reservoir 30 is pumped from the first conduit device 51 to the second conduit device 52 and then enters the soil 61 from the outlet 12 of the carrier 10 (as shown by the arrows in FIGS. 8 and 9) to properly adjust soil moisture; on the other hand, when the soil moisture of the pot 60 has reached the setting value, the motor pump 50 ceases pumping water.

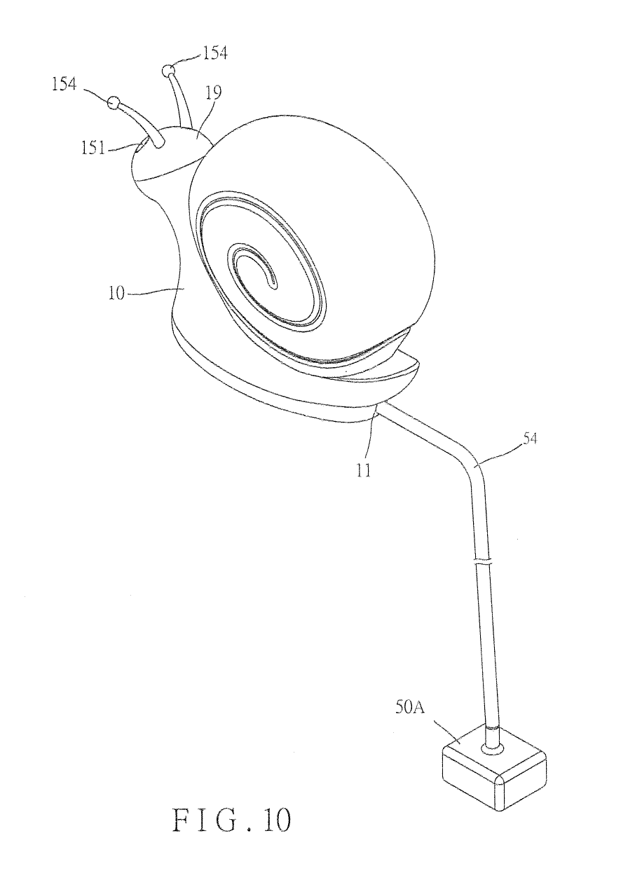

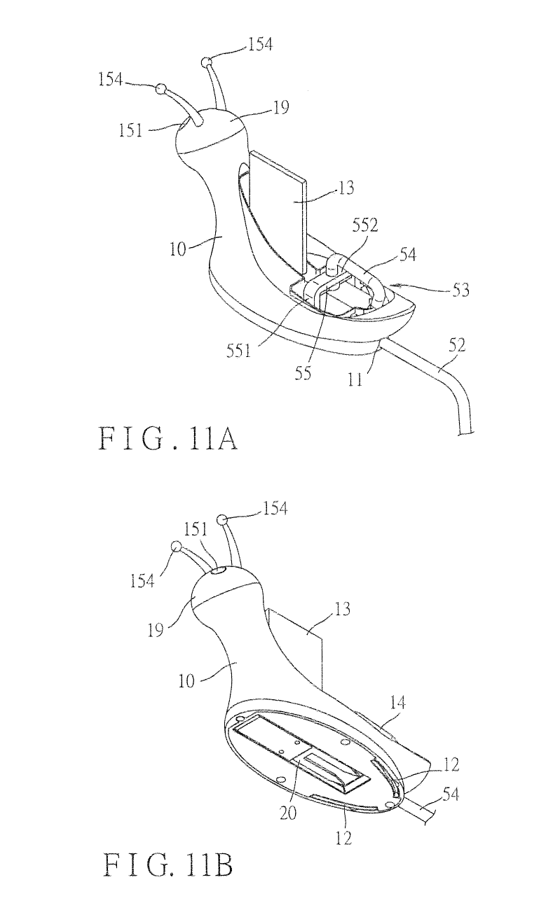

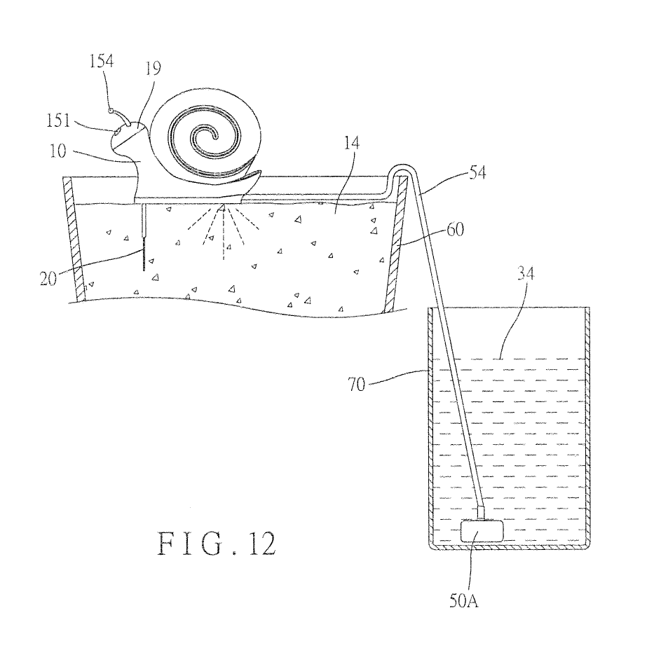

FIG. 10, FIG. 11A, FIG. 11B, and FIG. 12 show another embodiment of the automatic plant-watering device; the components are mostly the same with the previous embodiment and comprise a carrier 10 and a moisture sensor 20 configured below the carrier 10; the major difference is that the motor pump 50A is configured outside the carrier 10 to pump water from an external reservoir 70. The motor pump 50A comprises a third conduit device 53 that passes through the inlet 11 of the carrier 10 and enters the carrier 10 to connect to the outlet 12 of the carrier 10, wherein the third conduit device 53 comprises a fourth conduit device 54 and a fifth conduit device 55. The fourth conduit device 54 may be a pipe, and the fifth conduit device 55 may comprise two distributary conduits 551 and 552 extending to the left and the right, respectively, to equally distribute the water pumped by the motor pump 50A to the two sides and out the outlet 12 of the carrier 10.

The implementation of the method of controlling watering by monitoring soil moisture using the above automatic plant-watering device is described in the following. Referring to FIG. 7 to FIG. 9, after moving the moisture sensor 20 to the operating position downward vertically, the carrier 10 carrying the reservoir 30 may be inserted into the soil 61 of the pot 60 by the moisture sensor 20. When using for The first time, the moisture memory function key 151 may be pressed under suitable soil moisture conditions, and the main board 13 saves this setting value as the control moisture mentioned above; in addition, the measuring frequency mentioned above is also se n the main board 13. Subsequently, the soil moisture can be actually measured by the moisture sensor 20 and then compared with the control moisture by the main board 13. The watering process is implemented when the ratio of the soil moisture to the control moisture is lower than the first control value. During the watering process, the water 34 stored in the reservoir 30 is pumped from the first conduit device 51 to the second conduit device 52 and then enters the soil 61 from the outlet 12 of the carrier 10 (as shown by the arrows in the FIGS. 8 and 9) to properly adjust soil moisture. After that, a waiting process is implemented to let the water sufficiently permeate in soil according to different soil permeability properties to prevent acquiring unrepresentative moisture data when the soil moisture is measured again due to the insufficient water permeation. When the ratio of the soil moisture to the control moisture is higher than the second control value, the motor pump 50 ceases pumping and the step of measuring the soil moisture according to the measuring frequency is implemented to ensure that the soil moisture is sufficient; when the ratio of the soil moisture to the control moisture is lower than the second control value, the watering process and the waiting process are returned to since the soil moisture is insufficient. By the repeated soil moisture measurement and repeated implementation of the watering process, the plants may not wither due to under-watering nor rot due to over-watering.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of controlling watering by monitoring soil moisture, comprising the steps of:
determining a control moisture and a measuring frequency;
measuring, by a moisture sensor, a soil moisture according to the measuring frequency;
implementing a watering process when the ratio of the soil moisture to the control moisture is lower than a first control value;
implementing a waiting process after finishing the watering process to let water sufficiently permeate in soil;
measuring, by the moisture sensor, the soil moisture after finishing the waiting process; and
implementing, when the ratio of the soil moisture to the control moisture is higher than a second control value, the step of measuring the soil moisture according to the measuring frequency; and implementing, when the ratio of the soil moisture to the control moisture is lower than the second control value, the watering process and the step of implementing the waiting process.

2. The method of controlling watering by monitoring soil moisture as claimed in claim 1, wherein the measuring frequency is once every 15 to 45 minutes.

3. The method of controlling watering by monitoring soil moisture as claimed in claim 1, wherein the first control vain is between 0.5 and 0.7.

4. The method of controlling watering by monitoring soil moisture as claimed in claim 1, wherein the waiting process takes time of 25 to 35 minutes.

5. The method of controlling watering by monitoring soil moisture as claimed in claim wherein the second control value is between 0.9 and 1.1.
